(19) United States
(12) Patent Application Publication
(10) Pub. No.: US 2004/0147313 A1
(43) Pub. Date: Jul. 29, 2004

(54) Excluding certain people from gaming at a casino

(76) Inventors: Tim Stanley, Henderson, NV (US); Jennifer Shatley, Henderson, NV (US); Mike Effner, Henderson, NV (US); Debbie Baumer, Reno, NV (US)

Correspondence Address: FENWICK & WEST LLP, SILICON VALLEY CENTER, 801 CALIFORNIA STREET, MOUNTAIN VIEW, CA, 94041, US

(21) Appl. No.: 10/688,278

(22) Filed: Oct. 16, 2003

Related U.S. Application Data
(60) Provisional application No. 60/419,180, filed on Oct. 16, 2002.

(51) Int. Cl. G06F 17/00

(52) U.S. Cl. 463/29

(57) ABSTRACT

Automatic restriction and exclusion of customers from one or multiple casino properties prevents problem gamblers and others from gaming. When a customer is to be excluded from gaming at the casino, a flag is set in the player account in a player database, including the type of restriction, such as whether the customer is excluded completely from the casino, or only restricted from certain activities. When the customer presents her loyalty card, her account is examined to determine whether she is excluded or restricted from the activity she is attempting to engage in. If so, the game is deactivated and a casino employee is notified. The system works in a multi-property environment including a plurality of casinos and indicates whether the restriction or exclusion applies at the property at which the customer is attempting to game.

### CROSS REFERENCE TO RELATED APPLICATIONS

This application claims the benefit of provisional application No. 60/419,180, filed on Oct. 16, 2002, and which is incorporated herein by reference.

### BACKGROUND OF THE INVENTION

1. Field of the Invention

The present invention relates generally to a system and method for restricting or excluding certain people from a gaming establishment, or from a group of establishments.

2. Description of the Related Art

It is occasionally necessary for casinos to prevent certain people from gaming at their establishments. Typically, this is because an individual has a problem with compulsive gambling. Alternatively, a person may simply be an unwelcome guest at the casino, for example because she was previously caught trying to cheat at one of the games.

In general, there are two groups of people who should be excluded in some form from gaming at casinos: Gaming Prohibited customers and Gaming Restricted customers. Gaming Prohibited customers are those customers who have been excluded from all gaming activity, including gambling, receiving casino mailings/offers, receiving credit, cashing checks, etc. Gaming Restricted customers are those customers who have been restricted from a specific type of gaming interaction. Examples of interaction types are receiving mailings such as direct mail or e-mail; telephone contact; receiving credit at the casino; and having check cashing privileges at the casino. Both Gaming Prohibited (“excluded”) and Gaming Restricted (“restricted”) customers may achieve that status either voluntarily or involuntarily, i.e. by requesting it, or by having it imposed upon them.

At present, a series of manual processes is used to identify customers who should be restricted or excluded. In many cases, the same data must be re-entered several times in different locations and computer systems, even at a single casino. This conventional method is both labor intensive and prone to error. Where multiple casino properties are involved, each casino must separately record the exclusion or restriction of the customer, and the opportunity for error is again present. Also, because of lag time between data from one casino reaching another casino and then being manually input, it is possible that an excluded or restricted customer may be able to game at another casino for a long period of time when she should actually be excluded. Similarly, where a customer has had her restriction or exclusion lifted, it may take a lengthy period before the lifting propagates to other casinos in the group, which is certainly undesirable from a public relations perspective.

Accordingly, what is needed is an improved method and system for excluding or restricting people from gaming at casino properties.

### SUMMARY OF THE INVENTION

The present invention enables the automatic restriction and exclusion of customers from multiple casino properties while increasing efficiency and reducing opportunity for error. An account is preferably created in a centralized player database for each player known to the casino. This database shares accounts for players at a plurality of casino properties. Players are typically known to the casino either because they have been issued a player loyalty card, or because they have previously provided their personal information to the casino in connection with winning a jackpot, e.g., by completing required tax forms. When a customer is excluded from gaming at any of the affiliated casinos, a flag is set in her account in the player database. In a preferred embodiment, the particular flag that is set includes information about the type of restriction, such as whether the customer is excluded completely from the casino, or only restricted from certain activities at the casino. In addition, the flag also preferably specifies whether the customer should be excluded from receiving promotional offers such as coupons, discounts, telephone calls, or comps. Also in a preferred embodiment, the account entry indicates whether the exclusion or restriction is voluntary or involuntary. Additionally, the database entry can indicate specific restrictions associated with individual casino properties.

When a customer at any of the casinos inserts her player loyalty card into a gaming machine, or presents her loyalty card to a casino employee who subsequently enters the information into the casino's computer system, the customer's account is accessed and examined to determine whether the customer is excluded or restricted. If the customer is excluded, or restricted from the activity the customer is attempting to engage in, then the game is preferably locked such that it cannot be played, and a casino employee is preferably notified immediately so that action can be taken, such as escorting the customer from the property. If the customer is not excluded, or if the customer is restricted from some activities but not the activity she is attempting to engage in, the game remains active and no other action is preferably taken.

As noted, because a single player database can be shared by multiple casino properties, when a player is restricted or excluded at one property, in a multi-property environment the entry in the player database preferably also includes a flag to indicate whether the exclusion is for one, some or all of the casino properties. When a customer attempts to game at one of the casino properties, not only is the restriction/exclusion information from the player database checked, but it is also evaluated against the property field to determine whether the restriction or exclusion applies at the property at which the customer is attempting to game. If so, then the customer is restricted or excluded as appropriate. If not, then the customer is allowed to game as usual.

### BRIEF DESCRIPTION OF THE DRAWINGS

FIG. 1 is a block diagram of a system in accordance with an embodiment of the present invention.

FIG. 2 is a flowchart illustrating a method in accordance with an embodiment of the present invention.

The figures depict preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

System Architecture

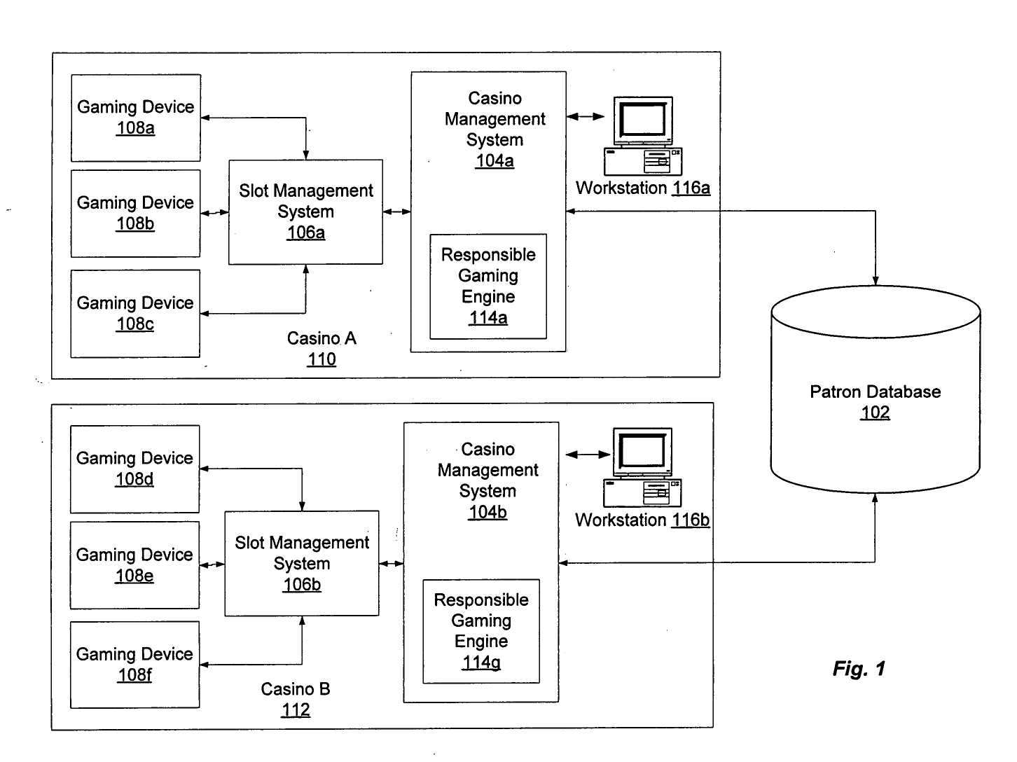

Referring now to FIG. 1, there is shown a block diagram of a system in accordance with the present invention. FIG. 1 depicts two casinos 110, 112, each connected to a common Patron Database (PDB) 102. Casino A 110 and Casino B 112 are illustrated to show that the present invention enables multiple casinos to share customer exclusion information between properties. Although there are two casinos shown in FIG. 1, the present invention is applicable to environments having more or fewer casinos as well, and is particularly advantageous for casinos having a large number of casino properties. Accordingly, where this description refers to operations at a single casino, it is only for ease of description, and should be understood to be equally applicable to a multiple casino environment. PDB 102 maintains accounts for each customer that is known to the casino, e.g., a member of the casino's affinity program. The customer's account is typically populated with information about the customer such as account number, name, address, transaction history, and a measure of the customer's value to the casino. The particular data included in the PDB 102 for each customer is not material to the present invention, except as it relates to exclusion/restriction as described below, and will typically vary depending on the needs of a particular casino or group of casinos. Where multiple casinos are affiliated with one another, a single PDB 102 may include accounts for customers of each casino in the affiliated group. Preferably, customers having accounts in PDB 102 are also issued player loyalty cards, which help to identify the customer to the casino at the time that a customer participates in gaming activities. A detailed explanation of the operation of one suitable player loyalty system is given in U.S. Pat. No. 6,183,362, titled “National Customer Recognition System and Method,” incorporated herein by reference. As shown in FIG. 1, casino 110 also includes a Casino Management System 104a, Responsible Gaming Engine 114a, Slot Data System 106a, and Gaming Devices 108. Although three Gaming Devices are shown, in actual practice there will be hundreds and sometimes thousands.

Casino management system (CMS) 104 receives customer data from card readers, workstations, and dumb terminals located at various venues throughout the casino and transmits the received data to the central PDB 102. In this embodiment, CMS 104 may be a single, centralized system supported on a central LAN, a distributed system comprising local management systems associated with each casino LAN, or a hybrid system including both centralized and distributed components. A preferred configuration for the management system depends on the data capacity of the network and the sizes of the various casino properties.

In one typical embodiment, CMS 104 handles the day-to-day gaming transactions at various casino venues. Data accumulated by the CMS 104 is updated to the PDB 102, where it may be accessed by casino personnel. In general, when customer information is required, CMS 104 first checks a data store associated with the local casino property, and if the data is not available there, it is retrieved from the PDB 102. On-line access to a customer's activities at all of its casino properties allows the casino company to implement cross-property incentive programs, manage responsible gaming programs and customer offer programs more effectively, and provide more personalized services to its customers. Data is available for a customer's gaming and non-gaming activities, giving the casino a more complete picture of the customer's expenditures while at the casino. For a more detailed view of cross-property incentive programs, see U.S. Pat. No. 5,761,647, “National Customer Recognition System and Method,” which is herein incorporated by reference.

CMS 104a also includes Responsible Gaming Engine 114a, which enables updating of customer accounts with exclusion information, and also is used to enforce exclusions and restrictions at casino 110. The operation of Responsible Gaming Engine 114a is described further below.

Slot Management System (SMS) 106 receives real-time data from the multiple gaming devices 108. In a preferred embodiment, one of the functions of SMS 106 is to track a player at the session level, i.e. to record a player's gaming activity between the time of carding-in and carding-out at a gaming device 108. Session level data is then transmitted to CMS, which updates the PDB. A suitable SMS is Bally Gaming & Systems' Slot Data System.

Gaming device 108 is any one of a multitude of kinds of gaming tables and slot machines found at a casino, including, e.g., slot machines, electronic video games and the like that offer a multitude of different gambling games, etc. In a preferred embodiment, each gaming device 108 includes a card reader (not shown). A customer inserts her affinity/loyalty card into the card reader to initiate a gaming session, and removes it to terminate the session. Note that a gaming device need not have an automatic card reader, but could instead be a table game or other game where card information is recorded manually by a casino employee via a terminal.

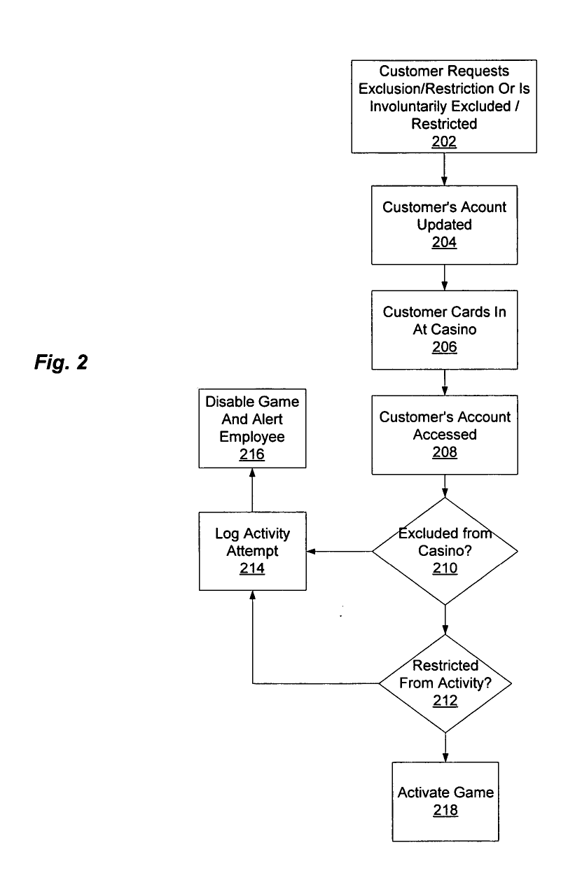

Referring now to FIG. 2, there is shown method for excluding certain customers from a casino in accordance with an embodiment of the present invention. First, a customer requests 202 either exclusion from the casino, or restriction from one or more casino activities, such as credit extension, check cashing privileges, etc. The exclusion/restriction can apply to a particular casino property, to a group of properties, or to all casino properties controlled by the casino company. Alternatively, the exclusion/restriction may be involuntary, such as where it is ordered by a gaming authority, or when the customer has been determined to be unwelcome in the casino. Once the request has been made, the customer's account is then updated 204, for example by an employee using a workstation 116. The change to the customer's account is preferably propagated through CMS 104 to PDB 102. In one embodiment, PDB 102 also includes a section of the user's account where log entries can be kept. These log entries can be used to detail interactions between the customer and the casino including, for example, details of what restriction is being applied, the period of the restriction, the employee who received the request to activate the restriction, the reason for the restriction, etc.

When a customer next arrives at the casino and wishes to play a game or use a service such as check cashing or credit extension, she presents her loyalty card to an employee or inserts it 206 into a card reader of a gaming machine 108. The player's card-in then causes her account to be downloaded 208 from PDB 102 to CMS 104. The Responsible Gaming Engine (RGE) 114, which is preferably a part of CMS 104, then examines the user's account to determine whether she is excluded 210 from the casino. If she is, then a log entry is preferably made 214 in the customer's account; the game machine is locked to prevent play 216, and a casino employee is preferably alerted to the fact that an excluded player is attempting to game. In one embodiment, this notification is made by sending an electronic message to a host terminal including the location of the game machine and additional data such as the name of the restricted customer. In an alternative embodiment, the machine may be identified by activating a light on the machine that is visible to casino employees, or by sounding an alarm. Also in a preferred embodiment, the location on the floor of the gaming machine being accessed by the customer is also passed to the employee so that the customer can be rapidly located. If the customer is not excluded 210, then RGE 114 next checks to see whether the customer is restricted 212 from the activity she is attempting to access. If so, then as with the case of an excluded customer, a log entry is made 214, the game machine is locked down 216 and employee is alerted. If the customer is not excluded and not restricted from the activity, then the game 214 is allowed to remain active, and the customer can enjoy playing as normal.

In a preferred embodiment, an alarm is also generated when a restricted or excluded user attempts to use a casino kiosk, for example to check her comps level or update personal information. Again, a casino employee is preferably notified of the location of the customer so that the customer can be intercepted as necessary.

In one embodiment, the present invention also includes a log entry functionality, in which a customer's account in the PDB 102 has a location for log entries detailing interactions between the casino and the customer, including any actions taken related to exclusions and/or restrictions. This allows casino employees or state regulatory agencies to review the case history electronically for a restricted or excluded customer, even where the source of the exclusion is a different property.

The present invention provides an efficient way of determining accurate numbers of patrons participating in the responsible gaming program at an enterprise level. It also provides the ability to query this information based on different criteria, such as the number of participants per state or property, when the restriction or exclusion was initiated, through what state program it was initiated, and, if applicable, the time period of the restriction or exclusion and the type of restriction or exclusion.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. For example, the particular functions of the Responsible Gaming Engine and so forth may be provided in many or one module.

Some portions of the above description present the feature of the present invention in terms of algorithms and symbolic representations of operations on information. These algorithmic descriptions and representations are the means used by those skilled in the casino management arts to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A method for automatically restricting access to a casino gaming machine, the method comprising:
storing in a customer account an indication that the customer's gaming activity should be restricted;
receiving electronically at the casino an indication that the customer is attempting to use a gaming machine at the casino; and
electronically preventing the gaming machine from being played by the customer.

2. The method of claim 1 further comprising notifying an employee of the casino that the customer is attempting to use the gaming machine.

3. The method of claim 2 wherein notifying the employee of the casino that the customer is attempting to use the gaming machine further includes notifying the employee of the location of the gaming machine.

4. A method for automatically restricting access to gaming machines at a plurality of casinos, the method comprising:
at a first casino, storing in a customer account an indication that the customer's gaming activity should be restricted at the casino;
at a second casino, receiving electronically an indication that the customer is attempting to use a gaming machine located at the second casino; and
electronically preventing the gaming machine from being played by the customer.

5. The method of claim 1 or 4 wherein storing the indication that the customer's gaming activity should be restricted further comprises storing a log entry in the customer account, the entry including details of the restriction.

6. The method of claim 5 wherein the details of the restriction include a reason for the restriction.

7. The method of claim 5 wherein the details of the restriction include an extent of the restriction.

8. The method of claim 5 wherein the details of the restriction include a period of the restriction.

9. The method of claim 1 or 4 wherein electronically receiving the indication further comprises:
receiving a card-in indication from a gaming machine, the card-in indication including a customer account identifier;
retrieving the customer account identified by the customer account identifier; and
determining from the retrieved customer account that the customer's gaming activity should be restricted.

10. The method of claim 1 or 4 wherein the indication that the customer should be excluded from the casino further indicates that the exclusion is voluntary.

11. The method of claim 1 or 4 wherein the indication that the customer should be excluded from the casino further indicates that the exclusion is involuntary.

12. The method of claim 1 or 4 wherein the restricted gaming activity includes obtaining credit.

13. The method of claim 1 or 4 wherein the restricted gaming activity includes cashing a check.

14. The method of claim 1 or 4 wherein the restricted gaming activity includes using a gaming machine.

15. The method of claim 1 or 4 wherein the restricted gaming activity includes playing a table game.

16. The method of claim 1 or 4 wherein the restricted gaming activity includes accruing comps.

17. The method of claim 1 or 4 further wherein storing the indication that the customer's gaming activity should be restricted further comprises storing an indication that the customer should not receive marketing materials.

18. The method of claim 4 further comprising notifying an employee of the second casino that the customer is attempting to use the gaming machine.

19. The method of claim 18 wherein notifying the employee of the second casino that the customer is attempting to use the gaming machine further includes notifying the employee of the location of the gaming machine.

20. A computer program product for automatically restricting access to a casino, the casino having a plurality of gaming machines, the computer program product including a computer-readable medium having computer program code for performing the operations of:
storing in a customer account an indication that the customer's gaming activity should be restricted;
receiving electronically at the casino an indication that the customer is attempting to use a gaming machine at the casino; and
electronically preventing the gaming machine from being played by the customer.

21. A computer program product for automatically restricting access to a casino gaming machine, the computer program product including a computer-readable medium having computer program code for performing the operations of:
at a first casino, storing in a customer account an indication that the customer's gaming activity should be restricted at the casino;
at a second casino, receiving electronically an indication that the customer is attempting to use a gaming machine located at the second casino; and
electronically preventing the gaming machine from being played by the customer.
